(19) United States
(12) Patent Application Publication
(10) Pub. No.: US 2022/0146659 A1
(43) Pub. Date: May 12, 2022

(54) BIOLOGICAL DETECTION DEVICE

(71) Applicant: AISIN CORPORATION, Kariya (JP)

(72) Inventor: Takashi OTANI, Kariya-shi (JP)

(73) Assignee: AISIN CORPORATION, Kariya (JP)

(21) Appl. No.: 17/452,593

(22) Filed: Oct. 28, 2021

(30) Foreign Application Priority Data
Nov. 9, 2020 (JP) 2020-186798

(51) Int. Cl. G01S 13/56; G01S 13/931

(52) U.S. Cl. CPC G01S 13/56; G01S 13/931

(57) ABSTRACT

A biological detection device including: a radio wave sensor including a transmission unit transmitting a transmission wave into a compartment and a reception unit receiving a reflected wave; a creation unit creating map information on the compartment based on the reflected wave; a specifying unit specifying a position and an intensity of a reflection source; an object detection unit detecting a motion of an object based on the reflected wave and outputting a detection result; a person detection unit detecting a person based on the map information and the detection result; a prediction unit generating ghost information by predicting information about a ghost corresponding to the person based on a position of the person and the position and the intensity of the reflection source; and a determination unit determining whether an object detected as the person is a ghost.

### CROSS REFERENCE TO RELATED APPLICATIONS

This application is based on and claims priority under 35 U.S.C. § 119 to Japanese Patent Application 2020-186798, filed on Nov. 9, 2020, the entire content of which is incorporated herein by reference.

### TECHNICAL FIELD

This disclosure relates to a biological detection device.

### BACKGROUND DISCUSSION

In the related art, there is a technique of calculating biological information (pulse wave, respiration, body motion, and the like) by irradiating a person with radio waves and performing frequency analysis on a Doppler shift of reflected waves. There is also a technique of determining presence or absence of a person (occupant) in a passenger compartment of a vehicle (passenger car or the like) based on transmission and reception of radio waves of a frequency modulated continuous wave (FMCW) system. In the FMCW system, a position irradiated with the radio waves and where reflected waves are reflected and a velocity at the position can be obtained from the Doppler shift. When these techniques are combined, it is possible to detect a person in the passenger compartment and biological information thereof. For example, see JP2019-126407A (which will be referred to also as Patent reference 1) and JP2020-101415A (which will be referred to also as Patent reference 2).

However, in the related art, a phenomenon (hereinafter, referred to as a ghost) may occur in which a person is detected in a place where no person is present in the passenger compartment.

A need thus exists for a biological detection device which is not susceptible to the drawback mentioned above.

### SUMMARY

A biological detection device according to an embodiment includes: a radio wave sensor including a transmission unit configured to transmit a FMCW modulated transmission wave into a passenger compartment of a vehicle and a reception unit configured to receive a reflected wave generated by the transmission wave being reflected by an object in the passenger compartment; a creation unit configured to create three-dimensional map information on the passenger compartment based on the reflected wave; a specifying unit configured to specify a position and a reflection intensity of a reflection source that is an object having a reflection intensity equal to or greater than a predetermined intensity with respect to the transmission wave in the three-dimensional map information; an object detection unit configured to detect a motion of an object in the passenger compartment based on a Doppler shift of the reflected wave and output a detection result; a person detection unit configured to detect one or more persons based on the three-dimensional map information and the detection result; a prediction unit configured to generate ghost information by predicting, for each of the persons detected by the person detection unit, information including a position about a ghost detected corresponding to the person based on a position of the person and the position and the reflection intensity of the reflection source; and a determination unit configured to determine, for each of the persons detected by the person detection unit, whether an object detected as the person is a ghost based on the position of the person and the ghost information.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic diagram of a vehicle according to an embodiment;

FIG. 2 is a block diagram showing functional configurations of a radio wave sensor and a controller according to the embodiment;

FIGS. 3A-3C are diagrams showing an outline of signal processing by a FMCW method according to the embodiment;

FIGS. 4A-4B are diagrams of ghost occurrence due to multipath according to the embodiment;

FIGS. 5A-5B are diagrams of ghost occurrence due to interference according to the embodiment;

FIG. 6 is a flowchart showing processing performed by the controller according to the embodiment;

FIG. 7 is a flowchart showing a first example of details of step S8 in FIG. 6;

FIG. 8 is a flowchart showing a second example of details of step S8 in FIG. 6;

FIG. 9 is a schematic diagram of a vehicle according to a modification;

FIG. 10 is a schematic diagram of a vehicle according to a modification; and

FIG. 11 is a schematic diagram of an arrangement state of the radio wave sensor 2 according to a modification.

### DETAILED DESCRIPTION

Hereinafter, an embodiment of a biological detection device disclosed here will be described with reference to the drawings.

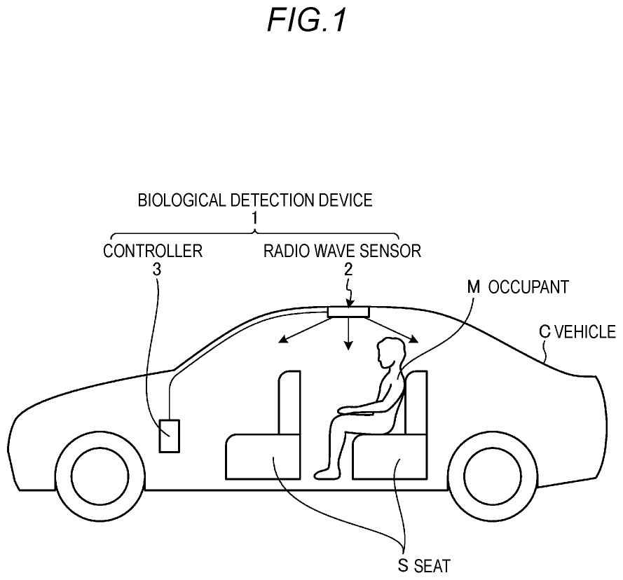

FIG. 1 is a schematic diagram of a vehicle C according to the embodiment. A radio wave sensor 2 and a controller 3 constituting a biological detection device 1 are disposed in a passenger compartment of the vehicle C. The radio wave sensor 2 is disposed at a ceiling portion in the passenger compartment. The controller 3 is disposed, for example, in a dashboard provided at a front end portion of the passenger compartment.

An occupant M is seated in a seat S. In the following description, the biological detection device 1 detects the occupant M (person) and determines a ghost. In the following description, among objects in the passenger compartment, an object having a reflection intensity equal to or greater than a predetermined intensity with respect to a transmission wave emitted by a transmission unit 21 of the radio wave sensor 2 is referred to as a reflection source. The reflection source is mainly a metal.

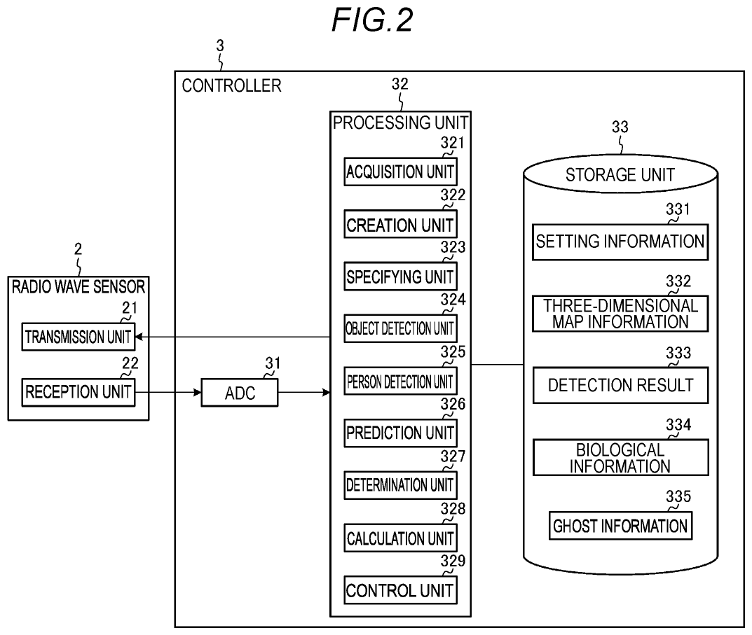

FIG. 2 is a block diagram showing functional configurations of the radio wave sensor 2 and the controller 3 according to the embodiment. The radio wave sensor 2 includes the transmission unit 21 and a reception unit 22.

The transmission unit 21 transmits (radiates) a FMCW modulated transmission wave in a wide range into the passenger compartment of the vehicle C. The reception unit 22 receives a reflected wave generated by the transmission wave being reflected by an object in the passenger compartment. The reception unit 22 includes plural receiving antennas.

The controller 3 is constituted by, for example, a micro controller unit (MCU) having an integrated circuit on which a hardware processor, a memory, and the like are mounted. The controller 3 includes an analog-to-digital converter (ADC) 31, a processing unit 32, and a storage unit 33.

The ADC 31 converts an analog signal acquired from the reception unit 22 of the radio wave sensor 2 into a digital signal and outputs the digital signal to the processing unit 32.

The storage unit 33 is a storage device such as a random access memory (RAM), a read only memory (ROM), a solid state drive (SSD), or a hard disk drive (HDD). The storage unit 33 stores a program executed by the processing unit 32, data necessary for executing the program, data generated by executing the program, and the like. The storage unit 33 stores, for example, setting information 331, three-dimensional map information 332, a detection result 333, biological information 334, and ghost information 335.

The setting information 331 stores various kinds of setting information such as a frequency range for determining a biological signal of a person and various kinds of threshold values (a reflection source threshold value for specifying a reflection source, a person threshold value for detecting a person, and the like).

The three-dimensional map information 332 is information indicating a three-dimensional object arrangement state in the passenger compartment, and is created by a creation unit 322 based on reflected wave information.

The detection result 333 is information on a detection result by an object detection unit 324.

The biological information 334 is biological information on a person calculated by a calculation unit 328.

The ghost information 335 is generated by a prediction unit 326 and includes a position and an intensity of a ghost corresponding to the occupant M.

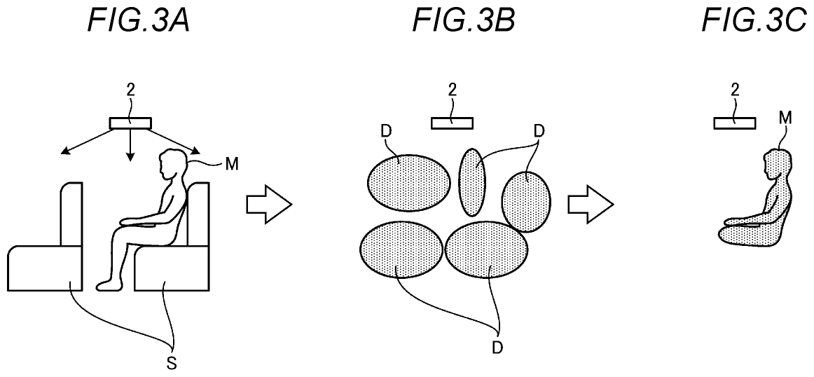

FIGS. 3A-3C are diagrams showing an outline of signal processing by a FMCW method according to the embodiment. As shown in FIG. 3A, first, the FMCW modulated transmission wave is transmitted from the transmission unit 21 of the radio wave sensor 2 into the passenger compartment of the vehicle C. The reception unit 22 of the radio wave sensor 2 receives the reflected wave.

Next, as shown in FIG. 3B, the creation unit 322 creates the three-dimensional map information in the passenger compartment based on the reflected wave. The three-dimensional map information includes, in addition to the occupant M, information on an object (reflection source) such as a metal having a high reflectance. That is, it is not possible to distinguish whether a recognized object is a metal or a person by using the three-dimensional map information alone.

Next, as shown in FIG. 3C, the occupant M is detected by object detection based on the Doppler shift of the reflected wave by the object detection unit 324 and person detection by a person detection unit 325. The biological information on the occupant M can also be calculated by the calculation unit 328. Processing of the processing unit 32 will be described in detail.

The processing unit 32 is constituted by, for example, a hardware processor such as a central processing unit (CPU). The processing unit 32 reads the program stored in the storage unit 33 and executes arithmetic processing. The processing unit 32 includes, as functional units, an acquisition unit 321, the creation unit 322, a specifying unit 323, the object detection unit 324, the person detection unit 325, the prediction unit 326, a determination unit 327, the calculation unit 328, and a control unit 329. Some or all of the units 321 to 329 may be constituted by hardware such as a circuit including an application specific integrated circuit (ASIC) or a field-programmable gate array (FPGA).

The acquisition unit 321 acquires the reflected wave information from the ADC 31.

The creation unit 322 creates three-dimensional map information on the passenger compartment based on the reflected wave information, and stores the three-dimensional map information as the three-dimensional map information 332 in the storage unit 33.

The specifying unit 323 specifies a position of the reflection source in the three-dimensional map information 332 created when the vehicle C is stopped.

The object detection unit 324 detects a motion of an object in the passenger compartment based on a Doppler shift of the reflected wave, and stores a detection result in the storage unit 33 as the detection result 333.

The person detection unit 325 detects one or more occupants M based on the setting information 331, the three-dimensional map information 332, and the detection result 333 when the vehicle C is stopped. When detecting the occupants M, the person detection unit 325 labels person signals corresponding to the occupants M in descending order of intensity.

The prediction unit 326 predicts, for each of the occupants detected by the person detection unit 325, information including a position about a ghost corresponding to the occupant based on a position of the occupant and the position and a reflection intensity of the reflection source, and generates ghost information. That is, attention is paid to a matter that a location where a signal intensity (hereinafter, also simply referred to as “intensity”) is large in the three-dimensional map information before a person signal is extracted is a portion where reflectance is high, which is a cause of the ghost, and thus, an occurrence position of the ghost is predicted based on the position of the occupant, and the position and the reflection intensity of the reflection source. Hereinafter, processing of the prediction unit 326 for each of a ghost derived from multipath and a ghost derived from interference will be described.

FIGS. 4A-4B are diagrams of ghost occurrence due to multipath according to the embodiment. FIG. 4A shows an actual state of the passenger compartment, and FIG. 4B shows the detected occupant M and a ghost (region A1).

When a signal reflected by the occupant M hits a reflection source R having a high reflectance, the signal is further reflected and then returns to the radio wave sensor 2, a ghost derived from multipath occurs. In particular, this problem is likely to occur when the vehicle C contains a large amount of metal and the passenger compartment is a sealed space.

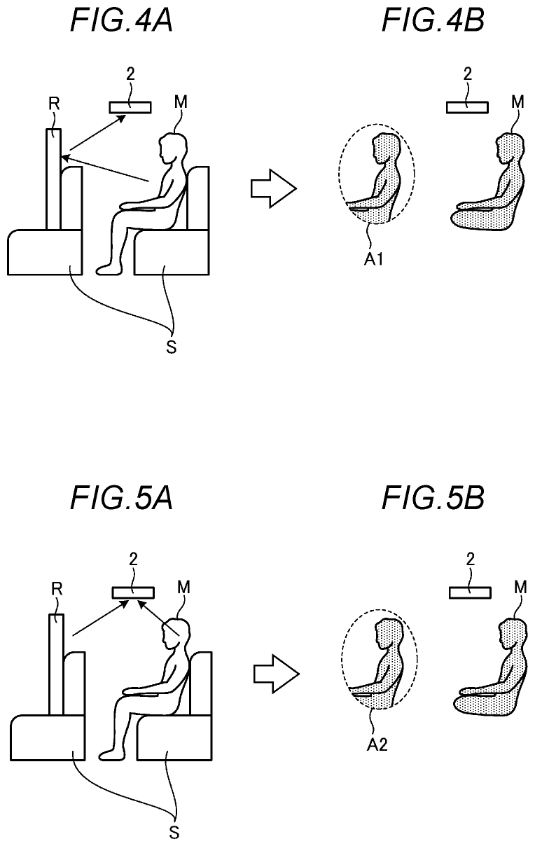

A signal intensity of a ghost signal is smaller than that of an original signal, but when the original signal is large, it may not be possible to distinguish whether a detected person signal corresponds to the actual occupant M or a ghost. Although FIGS. 4A-4B show only one occupant M, the number of occupants M may be two or more (the same applies to FIGS. 5A-5B).

The prediction unit 326 calculates a position and a signal intensity of the ghost derived from the multipath as follows. The prediction unit 326 predicts, for each of the occupants M detected by the person detection unit 325, a position and an intensity of the ghost detected when a reflected wave of a transmission wave by the occupant M is further reflected by the reflection source R and then incident on the radio wave sensor 2, based on a distance from a position of the occupant M to a position of the reflection source R and a distance from the position of the reflection source R to the radio wave sensor 2, and stores a prediction result in the storage unit 33 as the ghost information 335 when the position is in the passenger compartment and the intensity is equal to or greater than a person threshold value.

The position of the ghost is predicted based on, for example, the distance from the position of the occupant M to the position of the reflection source R, the distance from the position of the reflection source R to the radio wave sensor 2, the position of the reflection source R, the position of the radio wave sensor 2, and the like. The intensity of the ghost is predicted based on the signal intensity of the occupant M, the signal intensity of the reflection source R, a positional relation between the reflection source R and the radio wave sensor 2, and the like.

FIGS. 5A-5B are diagrams of ghost occurrence due to interference according to the embodiment. FIG. 5A shows an actual state of the passenger compartment, and FIG. 5B shows the detected occupant M and a ghost (region A2).

When the distance from the radio wave sensor 2 to the reflection source R and the distance from the radio wave sensor 2 to the occupant M are equal to each other (including an almost equal case), two reflected waves received by the reception unit 22 of the radio wave sensor 2 interfere with each other, and a ghost derived from the interference is generated. In particular, this problem is likely to occur when the vehicle C contains a large amount of metal and the passenger compartment is a sealed space.

A signal intensity of a ghost signal is smaller than that of an original signal, but when the original signal is large, it may not be possible to distinguish whether a detected person signal corresponds to the actual occupant M or a ghost.

Therefore, the prediction unit 326 calculates a position and a signal intensity of the ghost derived from the interference as follows. The prediction unit 326 predicts, for each of the occupants M detected by the person detection unit 325, the position of the ghost detected by interference between a reflected wave of a transmission wave by the occupant M and a reflected wave of a transmission wave by the reflection source R, based on the distance from the radio wave sensor 2 to the position of the occupant M and the distance from the radio wave sensor 2 to the position of the reflection source R.

More specifically, the prediction unit 326 determines one whose signal intensity after the interference is equal to or greater than the person threshold value as a ghost. The signal intensity after the interference is calculated from the distance and an angle from the radio wave sensor 2 to the reflection source R, the distance and an angle from the radio wave sensor 2 to the occupant M, an intensity of a signal reflected by the reflection source R, an intensity of a signal reflected by the occupant M, and the like.

Returning to FIG. 2, the prediction unit 326 excludes the ghost from processing targets when a predicted position of the ghost is outside the vehicle C. Since a ghost signal is generally smaller than a person signal due to signal reflection and interference, a signal having a larger labeling number is more likely to be a ghost.

The determination unit 327 determines, for each of the occupants M detected by the person detection unit 325, whether the occupant M is a ghost based on the position of the occupant M and the ghost information.

The prediction unit 326 may further predict, as the ghost information 335, a motion of the ghost when the occupant M corresponding to the ghost moves, based on plural detection results obtained by the person detection unit 325 in time series. In this case, the determination unit 327 determines whether the occupant M is a ghost based on the motion of the occupant M and information on the motion of the ghost in the ghost information 335 for each of the occupants M detected by the person detection unit 325 based on the plural detection results obtained by the person detection unit 325 in time series.

The calculation unit 328 calculates biological information with a motion related to the occupant M based on the detection result 333 and the like. An example of the biological information is a heart rate of the occupant M. When the transmission wave from the transmission unit 21 is reflected by a chest of the occupant M, an influence of a Doppler effect by the chest vibrating in a front-rear direction is reflected in the reflected wave. Therefore, the calculation unit 328 calculates the biological information based on a Doppler frequency derived from a signal of the reflected wave.

The control unit 329 performs an operation other than operations performed by the units 321 to 328.

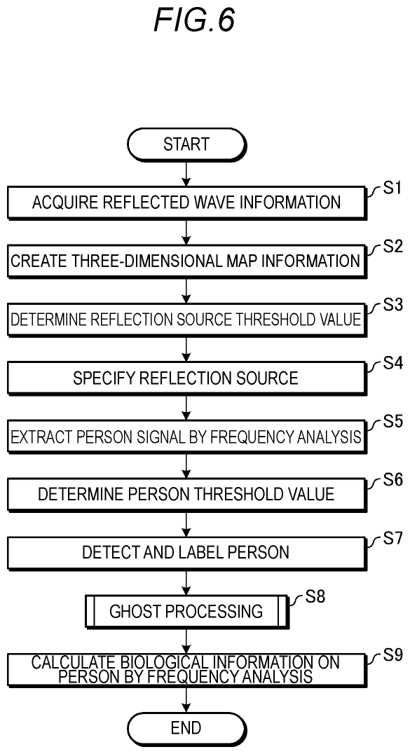

FIG. 6 is a flowchart showing processing performed by the controller 3 according to the embodiment. In step S1, the acquisition unit 321 acquires reflected wave information from the ADC 31.

Next, in step S2, the creation unit 322 creates the three-dimensional map information 322 on the passenger compartment based on the reflected wave information.

Next, in step S3, the creation unit 322 determines a reflection source threshold value based on a maximum value of an intensity of a signal or the like.

Next, in step S4, the specifying unit 323 specifies a position of a reflection source in the three-dimensional map information 332 using the reflection source threshold value.

Next, in step S5, after the object detection unit 324 detects an object in the passenger compartment, the person detection unit 325 extracts a person signal by frequency analysis.

Next, in step S6, the person detection unit 325 determines a person threshold value based on a maximum value of an intensity of the person signal or the like.

Next, in step S7, the person detection unit 325 detects the occupants M, and labels person signals corresponding to the occupants M in descending order of intensity.

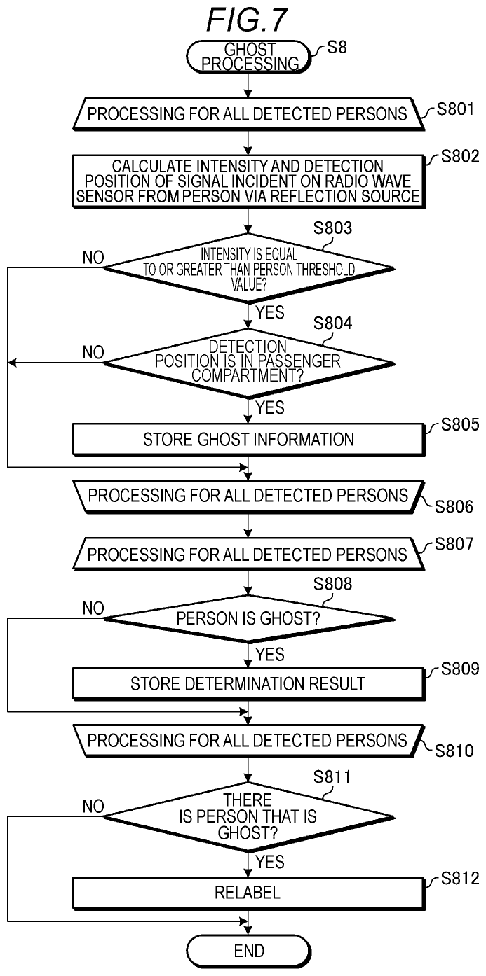

Next, in step S8, the processing unit 32 performs ghost processing. FIG. 7 is a flowchart showing a first example (in the case of the ghost derived from the multipath) of details of step S8 in FIG. 6.

First, in steps S801 to S806, processing of steps S802 to S805 are performed for all detected persons (person signals).

In step S802, the prediction unit 326 calculates an intensity and a detection position of a signal incident on the radio wave sensor 2 from the occupant M via the reflection source.

Next, in step S803, the prediction unit 326 determines whether the intensity is equal to or greater than the person threshold value, and the processing proceeds to step S804 if Yes and skips steps S804 and S805 if No.

Next, in step S804, the prediction unit 326 determines whether the detection position is in the passenger compartment, and the processing proceeds to step S805 if Yes and skips step S805 if No.

In step S805, the prediction unit 326 stores a calculation result (the position, the intensity, and the like of the ghost) in the storage unit 33 as the ghost information 335.

After processing of steps S801 to S806, in steps S807 to S810, processing of steps S808 and S809 are performed on all the detected persons (person signals).

In step S808, the determination unit 327 determines whether the occupant M is a ghost based on the position of the occupant M (person) and the ghost information (the position, the intensity, and the like of the ghost), and the processing proceeds to step S809 if Yes and skips step S809 if No.

In step S809, the determination unit 327 stores a determination result in the storage unit 33. For example, a part determined to be a ghost is deleted from the detection result of the person by the person detection unit 325.

After processing of steps S807 to S810, in step S811, the person detection unit 325 determines whether there is a person (person signal) that is a ghost, and the processing proceeds to step S812 if Yes and ends the processing if No.

In step S812, the person detection unit 325 relabels remaining person signals in descending order of intensity.

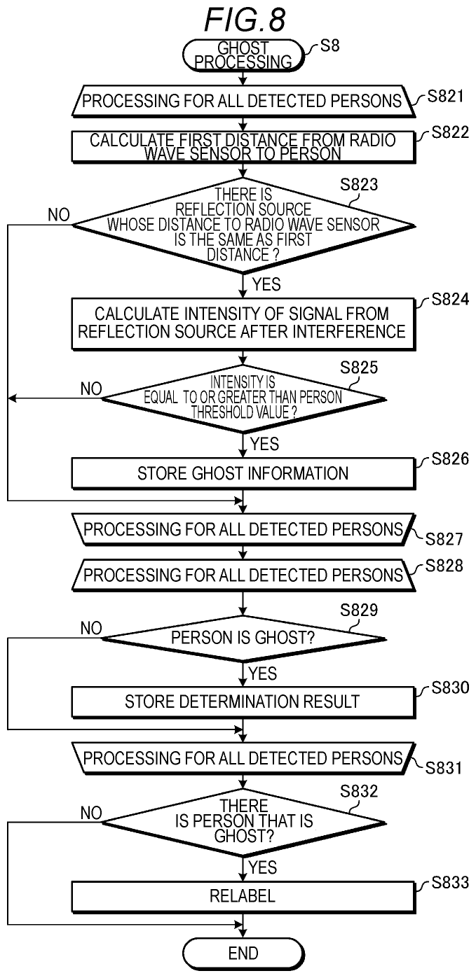

FIG. 8 is a flowchart showing a second example (in the case of the ghost derived from the interference) of details of step S8 in FIG. 6.

First, in steps S821 to S827, processing of steps S822 to S826 are performed for all detected persons (person signals).

In step S822, the prediction unit 326 calculates a first distance that is a distance from the radio wave sensor 2 to the occupant M (person).

Next, in step S803, the prediction unit 326 determines whether there is a reflection source whose distance to the radio wave sensor 2 is the same as the first distance (including a case where the distance is equal to or less than a predetermined distance threshold value), and the processing proceeds to step S824 if Yes and skips steps S824 to S826 if No.

In step S824, the prediction unit 326 calculates an intensity of the signal incident on the radio wave sensor 2 from the reflection source after interference with the reflected wave (signal) by the occupant M.

Next, in step S825, the prediction unit 326 determines whether the intensity is equal to or greater than the person threshold value, and the processing proceeds to step S826 if Yes and skips step S826 if No.

In step S826, the prediction unit 326 stores a calculation result (the position, the intensity, and the like of the ghost) in the storage unit 33 as the ghost information 335.

After processing of steps S821 to S827, in steps S828 to S831, processing of steps S829 and S830 are performed on all the detected persons (person signals).

In step S829, the determination unit 327 determines whether the occupant M is a ghost based on the position of the occupant M (person) and the ghost information (the position, the intensity, and the like of the ghost), and the processing proceeds to step S830 if Yes and skips step S830 if No.

In step S830, the determination unit 327 stores a determination result in the storage unit 33. For example, a part determined to be a ghost is deleted from the detection result of the person by the person detection unit 325.

After processing of steps S828 to S831, in step S832, the person detection unit 325 determines whether there is a person (person signal) that is a ghost, and the process proceeds to step S833 if Yes and ends the process if No.

In step S833, the person detection unit 325 relabels remaining person signals in descending order of intensity.

Returning to FIG. 6, after step S8, in step S9, the calculation unit 328 performs frequency analysis on each of the labeled person signals and calculates biological information.

In this way, according to the biological detection device 1 of the embodiment, it is possible to determine with high accuracy whether a detected person is a ghost by generating ghost information based on the position of the occupant M, and the position and the reflection intensity of the reflection source. That is, it is possible to prevent erroneous detection due to a ghost and to detect a person with high accuracy.

It is possible to cope with both a case where the detected person is a ghost derived from the multipath and a case where the detected person is a ghost derived from the interference.

It is possible to determine with high accuracy whether the detected person is a ghost by predicting the motion of the ghost when the occupant M corresponding to the ghost moves.

When the position of the ghost is outside the vehicle C, it is possible to exclude an unnecessary ghost from the processing targets and reduce the processing by excluding the ghost.

### (Modification)

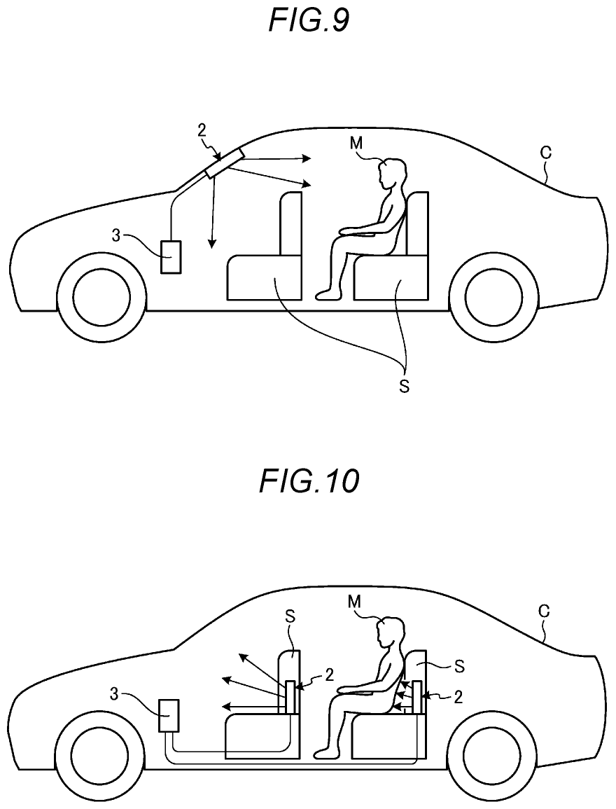

FIG. 9 is a schematic diagram of the vehicle C according to a modification. In a passenger compartment of the vehicle C, the radio wave sensor 2 may be disposed in a front portion instead of a ceiling to detect an occupant and calculate biological information.

FIG. 10 is a schematic diagram of the vehicle C according to a modification. In a passenger compartment of the vehicle C, the radio wave sensor 2 may be disposed inside each seat S instead of the ceiling or the front portion to detect the occupant and the calculate biological information.

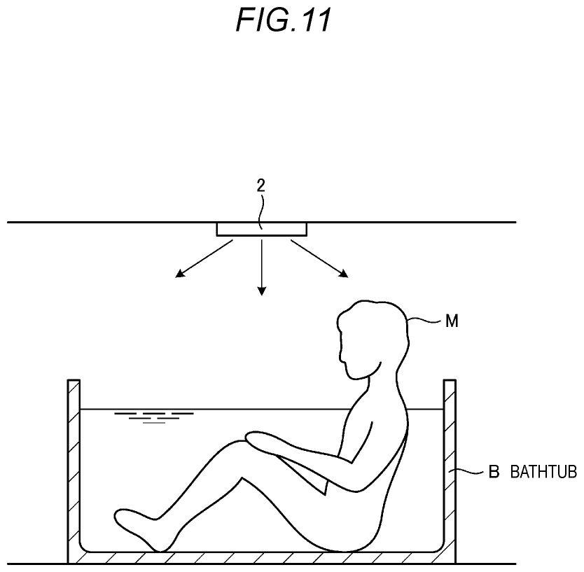

FIG. 11 is a schematic diagram of an arrangement state of the radio wave sensor 2 in a modification. The radio wave sensor 2 may be disposed at a ceiling portion above a bathtub B in a bathroom to perform occupant detection and biological information detection. In this way, for example, when a sudden illness occurs in an elderly person who is taking a bath, the sudden illness can be detected with high accuracy if there is a predetermined change in a pulse wave, respiration, or a body motion of the elderly person.

The program executed by the controller 3 may be stored in a computer-readable storage medium such as a CD-ROM, a CD-R, a memory card, a digital versatile disk (DVD), or a flexible disk (FD) as a file in an installable format or an executable format and provided as a computer program product. The program may be stored in a computer connected to a network such as the Internet and provided by being downloaded via the network. The program may be provided or distributed via the network such as the Internet.

While the embodiment disclosed here has been described above, the embodiment has been presented by way of example only, and is not intended to limit the scope of the disclosure. Indeed, the novel embodiment may be embodied in a variety of other forms, and various omissions, substitutions and changes may be made without departing from the spirit of the disclosure. The embodiment and modifications thereof are included in the scope and gist of the disclosure, and are also included in the inventions described in the claims and equivalents thereof.

For example, among reflection sources in the passenger compartment, another reflection source between the reflection source and the radio wave sensor 2 is less likely to cause ghost occurrence, and thus may be excluded from targets of ghost calculation.

Further, among the detected person signals, a person signal having a maximum intensity is less likely to be a ghost signal, and thus may be excluded from the targets of ghost calculation.

A biological detection device according to an embodiment includes: a radio wave sensor including a transmission unit configured to transmit a FMCW modulated transmission wave into a passenger compartment of a vehicle and a reception unit configured to receive a reflected wave generated by the transmission wave being reflected by an object in the passenger compartment; a creation unit configured to create three-dimensional map information on the passenger compartment based on the reflected wave; a specifying unit configured to specify a position and a reflection intensity of a reflection source that is an object having a reflection intensity equal to or greater than a predetermined intensity with respect to the transmission wave in the three-dimensional map information; an object detection unit configured to detect a motion of an object in the passenger compartment based on a Doppler shift of the reflected wave and output a detection result; a person detection unit configured to detect one or more persons based on the three-dimensional map information and the detection result; a prediction unit configured to generate ghost information by predicting, for each of the persons detected by the person detection unit, information including a position about a ghost detected corresponding to the person based on a position of the person and the position and the reflection intensity of the reflection source; and a determination unit configured to determine, for each of the persons detected by the person detection unit, whether an object detected as the person is a ghost based on the position of the person and the ghost information.

With such a configuration, it is possible to determine with high accuracy whether an object detected as a person is a ghost by generating the ghost information based on the position of the person, and the position and the reflection intensity of the reflection source.

In the biological detection device, the prediction unit may predict, for each of the persons detected by the person detection unit, a position of the ghost detected when the reflected wave of the transmission wave by the person is further reflected by the reflection source and then incident on the radio wave sensor based on a distance from the position of the person to the position of the reflection source and a distance from the position of the reflection source to the radio wave sensor.

With such a configuration, it is possible to determine with high accuracy whether an object detected as a person is a ghost derived from multipath.

In the biological detection device, the prediction unit may predict, for each of the persons detected by the person detection unit, a position of the ghost detected by interference between the reflected wave of the transmission wave by the person and the reflected wave of the transmission wave by the reflection source based on a distance from the radio wave sensor to the position of the person and a distance from the radio wave sensor to the position of the reflection source.

With such a configuration, it is possible to determine with high accuracy whether an object detected as a person is a ghost derived from interference.

In the biological detection device, the prediction unit may further predict, as the ghost information, a motion of the ghost when the person corresponding to the ghost moves based on plural detection results obtained by the person detection unit in time series, and the determination unit may determine whether the object detected as the person is a ghost based on a motion of the person and information on the motion of the ghost in the ghost information for each of the persons detected by the person detection unit based on the plural detection results obtained by the person detection unit in time series.

With such a configuration, it is possible to determine with high accuracy whether an object detected as a person is a ghost by predicting the motion of the ghost when the person corresponding to the ghost moves.

In the biological detection device, the prediction unit may exclude the ghost from a determination target when a predicted position of the ghost is outside the vehicle.

With such a configuration, an unnecessary ghost can be excluded from processing targets, and processing can be reduced.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A biological detection device comprising:
a radio wave sensor including a transmission unit configured to transmit a frequency modulated continuous wave (FMCW) modulated transmission wave into a passenger compartment of a vehicle and a reception unit configured to receive a reflected wave generated by the transmission wave being reflected by an object in the passenger compartment;
a creation unit configured to create three-dimensional map information on the passenger compartment based on the reflected wave;
a specifying unit configured to specify a position and a reflection intensity of a reflection source that is an object having a reflection intensity equal to or greater than a predetermined intensity with respect to the transmission wave in the three-dimensional map information;
an object detection unit configured to detect a motion of an object in the passenger compartment based on a Doppler shift of the reflected wave and output a detection result;
a person detection unit configured to detect one or more persons based on the three-dimensional map information and the detection result;
a prediction unit configured to generate ghost information by predicting, for each of the persons detected by the person detection unit, information including a position about a ghost detected corresponding to the person based on a position of the person and the position and the reflection intensity of the reflection source; and
a determination unit configured to determine, for each of the persons detected by the person detection unit, whether an object detected as the person is a ghost based on the position of the person and the ghost information.

2. The biological detection device according to claim 1, wherein
the prediction unit predicts, for each of the persons detected by the person detection unit, a position of the ghost detected when the reflected wave of the transmission wave by the person is further reflected by the reflection source and then incident on the radio wave sensor based on a distance from the position of the person to the position of the reflection source and a distance from the position of the reflection source to the radio wave sensor.

3. The biological detection device according to claim 1, wherein
the prediction unit predicts, for each of the persons detected by the person detection unit, a position of the ghost detected by interference between the reflected wave of the transmission wave by the person and the reflected wave of the transmission wave by the reflection source based on a distance from the radio wave sensor to the position of the person and a distance from the radio wave sensor to the position of the reflection source.

4. The biological detection device according to claim 1, wherein
the prediction unit further predicts, as the ghost information, a motion of the ghost when the person corresponding to the ghost moves based on plural detection results obtained by the person detection unit in time series, and
the determination unit determines whether the object detected as the person is a ghost based on a motion of the person and information on the motion of the ghost in the ghost information for each of the persons detected by the person detection unit based on the plural detection results obtained by the person detection unit in time series.

5. The biological detection device according to claim 1, wherein
the prediction unit excludes the ghost from a determination target when a predicted position of the ghost is outside the vehicle.
